(19) United States
(12) Patent Application Publication
(10) Pub. No.: US 2010/0030627 A1
(43) Pub. Date: Feb. 4, 2010

(54) SYSTEM AND METHOD OF MANAGING PROJECT TEMPLATES

(76) Inventors: Christopher Lee, Highland, UT (US); Justin Biggs, Springville, UT (US); Brytt Cloward, Springville, UT (US)

Correspondence Address: ADVANTIA LAW GROUP, 9035 SOUTH 1300 EAST, SUITE 200, SANDY, UT, 84094, US

(21) Appl. No.: 12/534,557

(22) Filed: Aug. 3, 2009

Related U.S. Application Data
(60) Provisional application No. 61/085,725, filed on Aug. 1, 2008.

(51) Int. Cl. G06Q 30/00; G06Q 10/00; G06Q 50/00; G06Q 20/00; G06F 17/30

(52) U.S. Cl. 705/11; 705/30; 705/26; 707/104.1; 707/E17.044

(57) ABSTRACT

There is a system and method of managing project templates, according to one embodiment of the invention, including a management system module configured to manage template information over a computerized system. The system includes a quality control module configured to review template information from the management system module for protocol compliance; and a categorization module configured to categorize template information from the management system module. The system also includes a registration module configured to register a user for a creator account with the management system module; wherein the creator account is configured to transmit template information to the management system module; and a compensation module configured to compensate the creator account for other users purchasing the user's template information. The system also includes a network module configured to couple the system to a computerized network.

### CROSS-REFERENCE TO RELATED APPLICATIONS

This invention claims priority, under 35 U.S.C. §120, to the U.S. Provisional Patent Application No. 61/085,725 to Lee et al. filed on Aug. 1, 2008, which is incorporated by reference herein.

### BACKGROUND OF THE INVENTION

1. Field of the Invention

The present invention relates to managing collaborative authorship, specifically to a system and method of managing project templates.

2. Description of the Related Art

Systems exist that allow for collaborative authorship. Software development, for example, has tools that allow for software engineers to simultaneously edit the same file. Such systems may lead to quicker authorship by dividing the work amongst coauthors. Advances have been made in the field. The following are examples and are incorporated by reference herein for their supporting teachings:

On the other hand, collaborative authorship systems may lead to poor quality works in cases where there is no quality control. In addition many systems do not provide a way to compensate the coauthors for their contribution to the work.

Authored works, for example memory books, sometimes involve a great level of detail. This level of detail allows for creativity but increases the time it takes to author such a work. To decrease the time it takes to author a work portions of other authored works may be reused and incorporated therein. It may be difficult, however, to find portions of authored works to reuse. Further, there are no systems for properly managing such templates.

U.S. Patent Application Publication No.: 2004/0249763, by David Vardi discloses a computer system with internally provided base-capacity and additional reserve capacity that is responsive to a capacity on demand signal to turn on and off additional computer capacity. A license manager interacts with the computer and receives from the computer system, capacity-related-metric information which dynamically varies over time and which causes the license manager to adjust licensing monitoring based on the capacity-related-metric information.

U.S. Patent Application Publication No.: 2004/0249762, by Caray E. Garibay et al. discloses a license management unit is described which provides for a web based access to digital records for software licenses. The digital records can indicate rights associated with the software license. A transaction history can be maintained including adjustments of the rights associated with the software license.

U.S. Patent Application Publication No.: 2004/0225611, by Mark J. Stefik et al. discloses a method, system and device for determining fees for access to digital works including associating a usage right with a digital work and which specifies a manner of use of the digital work and (i) a fee specification including a maximum price and a best price specification indicating a best price to be charged to a consumer upon exercising the manner or (ii) a price to be charged and a markup specification indicating a markup percentage to the price to be charged to a consumer upon exercising the manner of use; determining when the consumer is entitled to the best price or the markup specification and if so, returning a difference between the maximum price and the best price to the consumer or adding the markup percentage to the price to be charged to the consumer upon exercising the manner of use, respectively.

U.S. Patent Application Publication No.: 2004/0236588, by Steve Millard et al. discloses a system and method for licensing content on an updated storage media is provided where new licensed content is downloaded and stored onto the updatable storage media containing licensing rights. The licensing rights are stored in a SMLD on the storage media. The rights will be authenticated by a rights management server somewhere on the Internet. If the rights management server determines that a user has rights to the new content, then the user is allowed to access and download the new content from a content server. The present invention may be utilized in various industries such as music, film, B2B, education, and television and may be embodied on various media such as DVD storage media, CD storage media, and hybrid optical disk media.

U.S. Patent Application Publication No. 2004/0249768, by Markko Kontio et al. discloses a method, system, and computer program product to control the access, copying, and/or transfer of a digital asset by mobile, wireless devices using a digital voucher. The digital voucher references a primary content that contains all of the expression for that particular asset and a secondary content that contains information that can be distilled out as a preview. The information in the primary content can be limited to a specified duration or a specific number of viewings. The author, owner, or possessor of the digital asset specifies the terms and conditions for distribution of the digital asset. The digital voucher authorizes the mobile, wireless device to access a specified primary or secondary content that may be located elsewhere in the network. The mobile, wireless device can download a copy of portions or all of the content depending on the terms specified in the voucher.

The inventions heretofore known suffer from a number of disadvantages which include being ineffective, inefficient, being expensive, being difficult to use, being unduly complex, being limited in application, being limited in adaptability, and being unreliable.

What is needed is a system and method of managing project templates that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available management systems and methods. Accordingly, the present invention has been developed to provide a system and method of managing project templates.

In one embodiment of the invention, there is a method of managing project templates, the method configured to manage template receipt, distribution, use, and compensation thereof on a computerized system. The method may include the step of registering a template creator account on a computerized system. The method may also include the step of receiving template information associated with the template creator account on a computing device. In addition, the method may include the step of reviewing the received template information for protocol compliance. The step of reviewing the received template information for protocol compliance may include the step of reviewing the received template for quality control through a quality control module.

The method may then include the step of making the received template information available to a consumer. The step of making the received template information available to a consumer may include the step of categorizing the received template information and associating metadata with an electronic template file. The method may also include the step of providing the received template information to a consumer on request. The step of providing the received template information to a consumer on request may include the step of purchasing the received template. The step of providing the received template information to a consumer on request may also include the step of editing the received template information.

Furthermore, the method may include the step of recording the request in association with the template creator account and crediting the template creator account. The step of recording the request in association with the template creator account may include the step of retaining a commission from the sale of the received template.

In another embodiment of the invention, there is a project management system configured to manage template receipt, distribution, use, and compensation thereof on a computerized system. The system may include a management system module configured to manage template information over a computerized system. The system may also include a quality control module in communication with the management system module configured to review template information from the management system module for protocol compliance. The system may include a categorization module in communication with the management system module and configured to categorize template information from the management system module. The categorization module may include a template module configured to include a name and a description of the template information. The categorization module may also include a keyword module configured to include a keyword of the template information.

In addition, the system may include a registration module in communication with the management system module and configured to register a user for a creator account with the management system module; wherein the creator account is configured to transmit template information to the management system module. The system may also include a compensation module in communication with the management system module and configured to compensate the creator account for other users purchasing the user's template information. The system may include a project editor module is communication with the management system module and configured to edit template information. Furthermore, the system may include a display module in communication with the management system module and configured to display template information over a computerized system. The system may include a database module in communication with the registration module, the management system module, and the categorization module configured to store template information over a computerized system. The database module may also include a library module in communication with the categorization module, the quality control module, and the management system module and configured to store, filter, and group template information. The system may also include a network module in communication with the management system module configured to couple the system to a computerized network. Moreover, the system may include a commission module in communication with the management system module configured to collect a commission from the template information purchase.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a sequence diagram illustrating interaction between a developer, a management system, and a user in a project management system, according to one embodiment of the invention;

FIG. 2 is a network diagram illustrating an outputted memory book and the network connections between a developer, a plurality of management system modules, and a user in a project management system, according to one embodiment of the invention;

FIG. 3 is a flow diagram of a quality control module and a categorization module in interaction with a developer and a user in a project management system, according to one embodiment of the invention;

FIGS. 4 and 5 together are a flow diagram of a project editor module in interaction with a user in a project management system, according to one embodiment of the invention;

FIG. 6 is an activity diagram illustrating sharing within a management system in a project management system, according to one embodiment of the invention; and

FIG. 7 is a flow diagram of a method of managing projects using a project management system, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

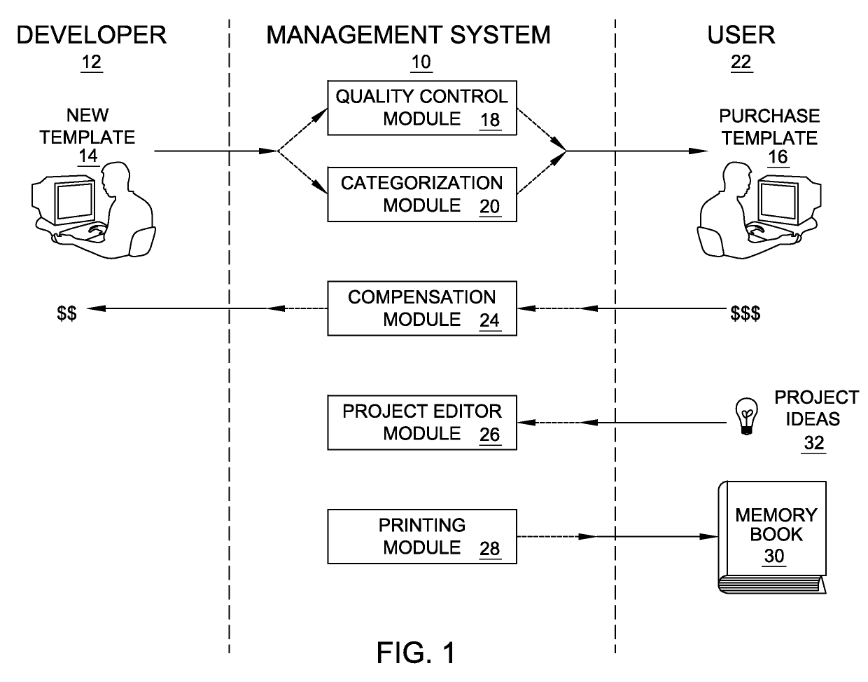

FIG. 1 is a sequence diagram illustrating interaction between a developer, a management system, and a user in a project management system, according to one embodiment of the invention. In the illustrated embodiment, a developer 12 creates a new template 14 and submits it to a management system 10. The management system 10 is configured to perform quality control on the new template 14 for protocol compliance through a quality control module 18. Likewise, the new template 14 is categorized by a categorization module 20 and displayed over a network. A user 22 purchases the new template 14 using the management system 10 over a network. The management system 10 also includes a compensation module 24 configured to perform the necessary functions to compensate the developer 12 for his or her work in creating the new template 14, that has been purchased by the user 22. The compensation module 24 is also configured to retain a commission from the sale of the new template 14 from the user 22 to the developer 12.

In addition, the management system 10 includes a project editor module 26 configured to enable a user 22 to edit templates, projects, and ideas. The management system 10 also includes a printing module 28 configured to create a digital memory book 30 by incorporating a plurality of project ideas 32 into a purchased template. Such project ideas may include but are not limited to artwork, pictures, and wording.

The developer 12, management system 10, and user 22 may be connected through one or more networks such as but not limited to the internet, a LAN, WAN, wireless network, cellular network, and etc.. The actions taken in the illustrated drawing may be taken by and/or through computing devices such as but not limited to personal computers, servers, cellular phones, personal digital assistants, and the like. The modules described in the drawing may be embodied in one or more devices, software programs, or the like on one or more of the devices described above. One or more modules may include device(s) or software resident on one or more devices owned or operated by a different party. As a non-limiting example, a developer may create and/or send a new template utilizing tools provided by the management system that may interoperate with one or more modules of the management system.

In operation of one embodiment of the invention, a developer creates a new template and uploads the new template to a management system over a network. The management system performs a quality control check for protocol compliance and then categorizes the new template into a category. The new template is then displayed over a network where a user purchases the new template from the management system and saves the new template to the user's network computing device. The management system compensates the developer for the purchase of the developer's new template. The management system also collects a commission from the purchase of the new template. The user then edits the new template with a project editor module using a network computing device. The user incorporates ideas, pictures, wording, artwork, etc. and creates a digital memory book.

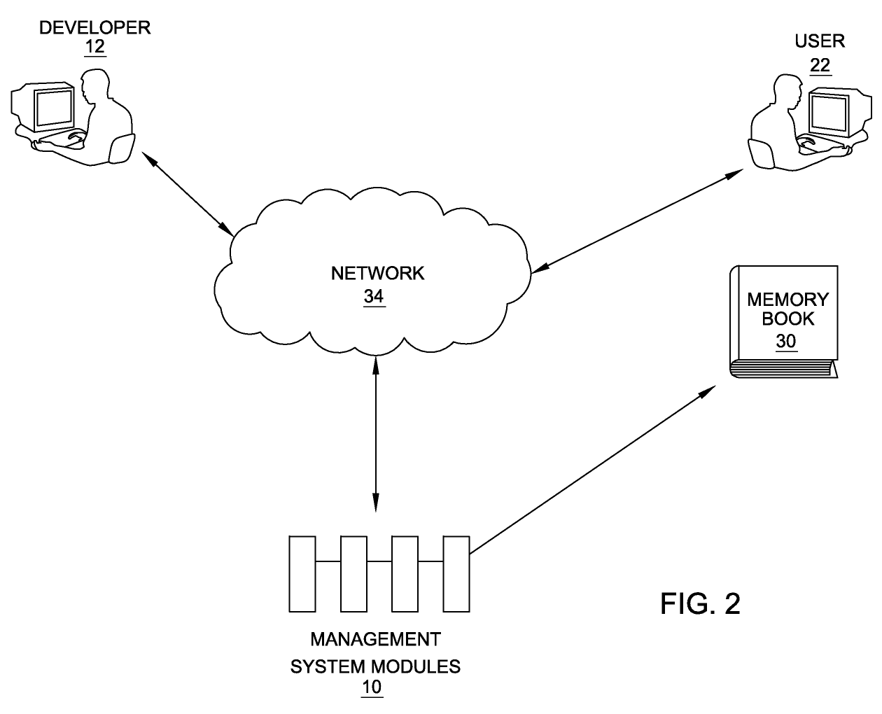

FIG. 2 is a network diagram illustrating an outputted memory book and the network connections between a developer, a plurality of management system modules, and a user in a project management system, according to one embodiment of the invention. In the illustrated embodiment, a developer 12 interacting with a computer connected to a network 34 may interact with a management system 10 having modules also in communication with the network 34. Similarly, a user 22 in communication with the network 34 interacts with the plurality of management system modules 10. The network 34 may be, but is not limited to, the Internet. A user 22 requests that a memory book 30 be produced by interacting with the plurality of management system modules 10. A memory book 30 may be physical or digital, and may be shipped or transmitted to a user 22.

In operation of one embodiment of the invention, a developer creates a new template and uploads the new template to a management system over a network. The new template is then displayed over a network. A user purchases the new template from the management system and saves the new template to the user's network computing device. The user incorporates ideas, pictures, wording, artwork, etc. and creates a digital memory book.

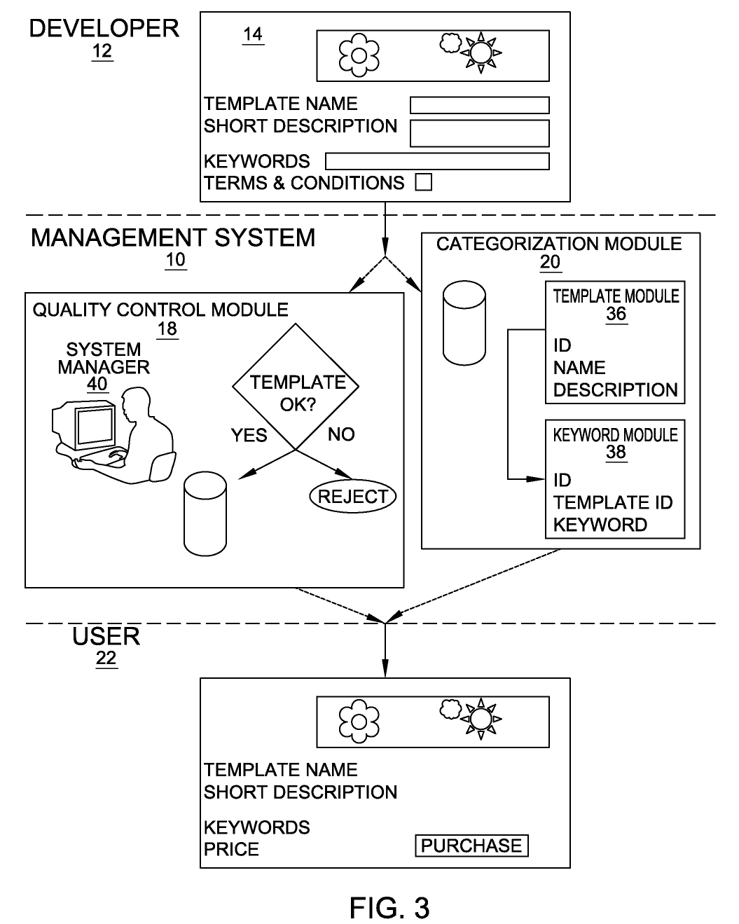

FIG. 3 is a detailed sequence diagram of a quality control module and a categorization module in interaction with a developer and a user in a project management system, according to one embodiment of the invention. In the illustrated embodiment, a developer 12 creates a template 14, giving it a template name, a short description, in addition to providing keyword descriptions, and agreeing to terms and conditions. A template 14 may include predetermined content and rules for incorporating additional content. An example includes a photo-album template wherein borders, photo sizes, angles, arrangements, accoutrements, and display items are preconfigured within certain defined parameters, but spaces for user photos are set aside and prepared to receive user photos according to a pattern. Accordingly, a user may be enabled to select a template photo album and provide digital photographs to a utility configured to operate together with the template to create a digital photo-album according to the template pattern and including the user photographs. The user may have some degree of choice in the operation of the utility and/or in how the photographs interconnect with the template and/or may have an opportunity to deviate from the template. A template may be stored as a data file in computer memory and may be transmitted accordingly. The template may follow a predefined data structure and may be stored in a database. The template file may call other files, such as but not limited to media files (jpg, gif, mpep, avi, mp3, and etc.) and may instruct a template viewing utility to display such. The template file may include one or more scripts configured to instruct a utility in the manner of integrating user content with the template or for performing other functions. The template file may include metadata regarding the template configured to assist in searching for and proper utilization of the template. A template may include measures, systems, code, and the like for digital rights management purposes.

There is also shown a management system 10 having a quality control module 18 and a categorization module 20 processes the template 14 for protocol compliance. The management system 10 may include one or more computing devices, such as but not limited to file servers and network servers configured to store and transmit information for a plurality of client/remote machines, such as but not limited to such that may be operated by developers and users. The illustrated quality control module 18 utilizes a system manager 40 to review the template 14. If the template 14 meets the standards of the protocol compliance then the template 14 is stored, otherwise it is rejected. Protocol compliance may check for successful utilizability of a template by a viewing utility, may check for inappropriate content, unauthorized scripts, appropriateness of metadata, check for fulfillment of specific minimum requirements, compare the template to existing templates to check for copies, and the like. Such may be accomplished through automation, one or more modules, human inspection, user feedback, and the like, and/or combinations thereof.

The categorization module 20 includes a template module 36 configured to store the name and the short description. Such may later be utilized in providing the content to users according to preferences, user settings, search queries, and the like. The categorization module 20 also includes a keyword module 38 configured to store keywords, associated with the template 14, in a relational database and indexes them for quick retrieval. The template 14 is purchased by a user 22 by reviewing the template along with the template's name, short description, keywords, and price.

In operation of one embodiment of the invention, a developer creates a new template and uploads the new template to a management system over a network. The management system performs a quality control check for protocol compliance and then categorizes the new template into a category. The new template is then displayed over a network. A user purchases the new template from the management system and saves the new template to the user's network computing device.

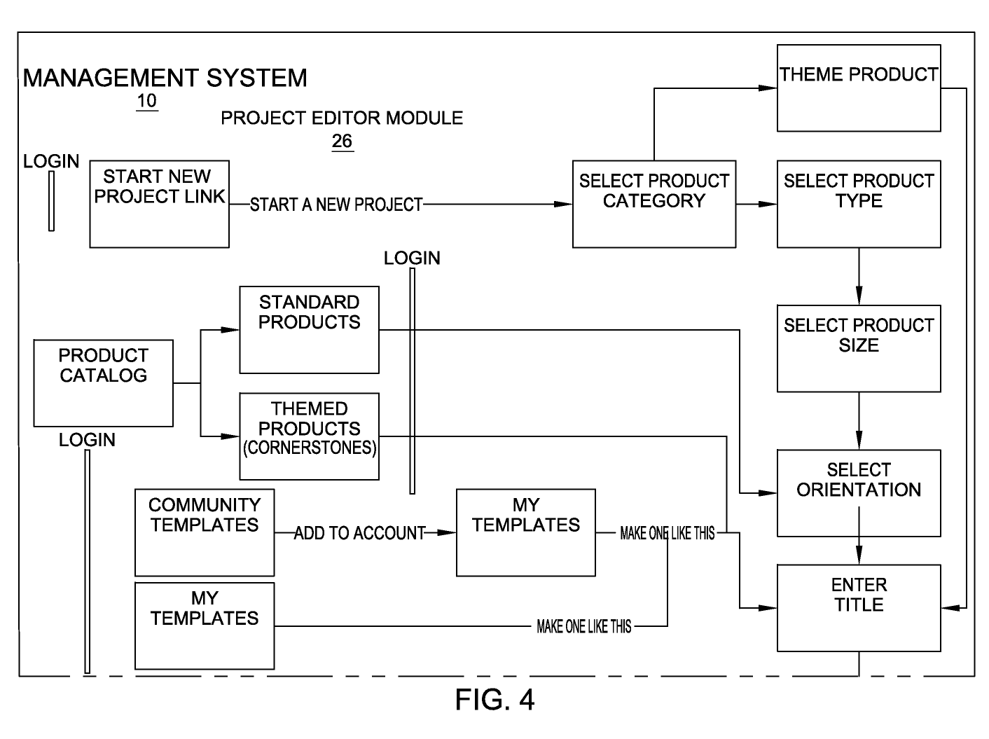

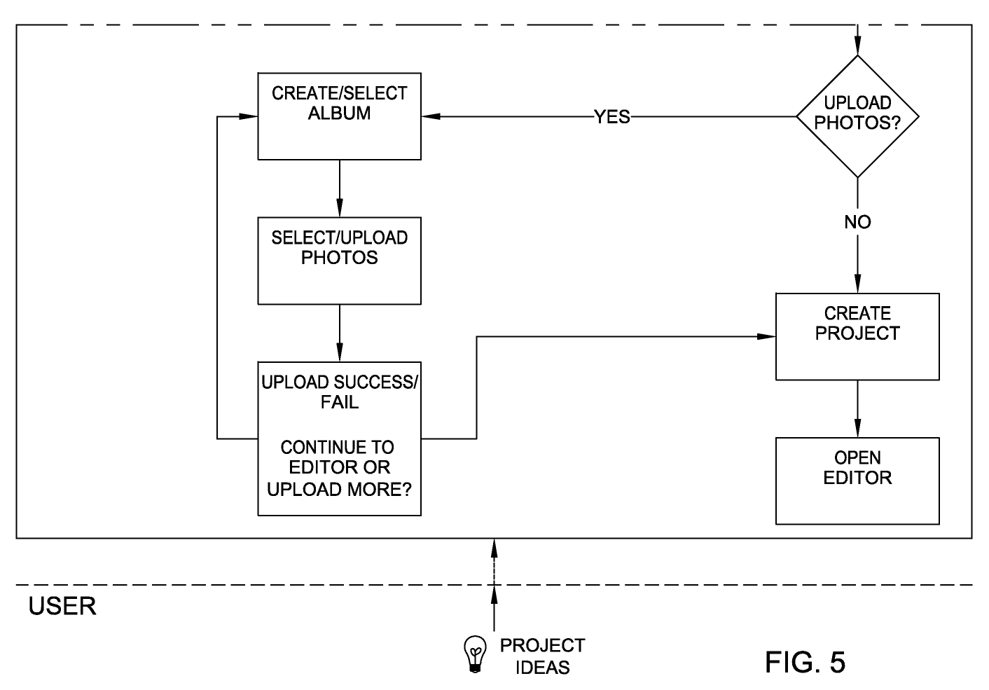

FIGS. 4 and 5 illustrate a detailed sequence diagram of a project editor module in interaction with a user in a project management system, according to one embodiment of the invention. The diagram illustrates the experience of interacting with an embodiment of the invention through a user perspective. In the illustrated embodiment, a user contributes ideas and inputs them into a management system 10 through the project editor module 26. Such project ideas may include but are not limited to artwork, pictures, and wording. The project editor module 26 facilitates the input of project ideas. The user selects through product categories and inputs artwork, pictures, wording etc. and creates a personalized template. The template points are configured to be currency for the template gallery.

In operation of one embodiment of the invention, a user is permitted to login through a network wherein several options are presented, including starting a new project and accessing a variety of templates and other products, including ones created/modified by the user as well as those created by a community of users. Through menus and/or other browsable/searchable displays of products, the user may select a product and may be provided with an opportunity to take the template as a whole or “make one like this” wherein the user may receive an editable version of a template or receive instructions and media sufficient to guide the user in creating a similar product. The user may select products, product types, sizes, orientations, and the like and may be permitted to edit products and/or provide metadata to be associated therewith, such as but not limited to providing a title for a project.

The user is enabled to upload photos to a project and therefore create/edit/select an album. Systems are in place to assist users with one or more steps in this process and to error check against software/hardware/user failures. The user may edit a new template with a project editor module using a network computing device. The user incorporates ideas, pictures, wording, artwork, etc. and creates a digital memory book. The user saves the template to the network computing device

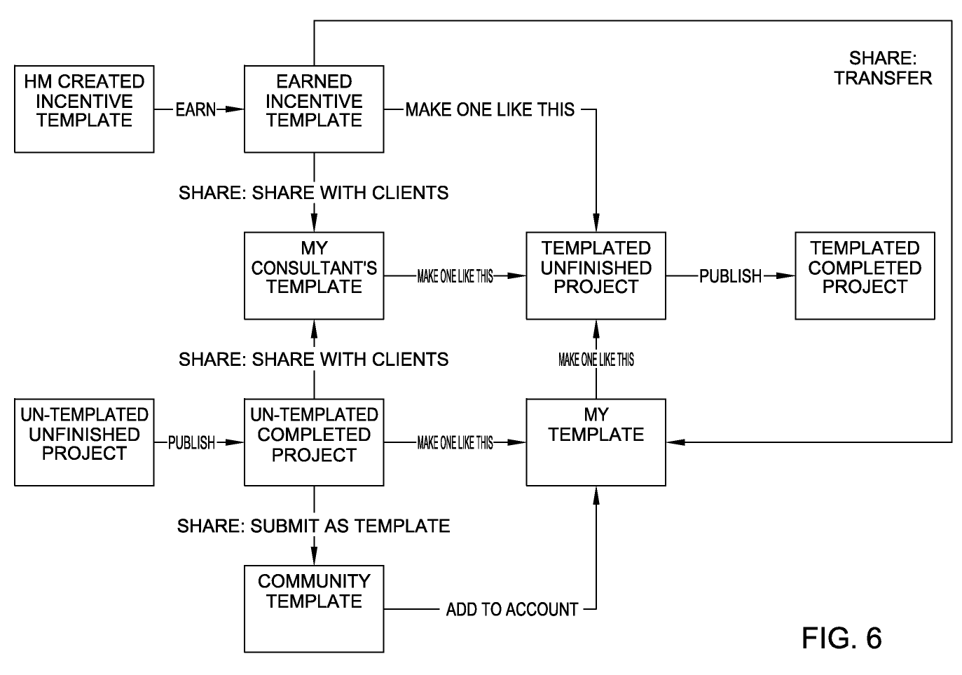

FIG. 6 is an activity diagram illustrating sharing within a management system in a project management system, according to one embodiment of the invention. There is shown a plurality of activity paths to arrive at a templated complete project. In general, a user will create an unfinished templated project and the act of publishing such (creating a physical book, or other manner of publishing the work) will be the final step in creating the templated completed project. Arriving at a templated unfinished project will generally require a ready made template of some sort, either from the collection of user templates already in the user's library (My Templates); a collection of templates from a user associate with the user (My Consultant's Tempalte) such as but not limited to a consultant, supervisor, mentor, up-line associate or other similar relationship to the user, and/or templates earned through an incentive system such as but not limited to rewards for referring other users, rewards for creating templates purchased by other users, random lotteries, and the like. In each case, the user may utilize a “make on like this” function that may be part of a module of the system wherein the template and/or associated media information is made available in an editor for use by the user.

Where a user has a library of templates available thereto, the user may have an option to share such with those that the user has recruited into the system and/or with others with whom the user has an association or relationship. A user may also create a template from scratch (un-templated unfinished project) and such may later be utilized to create other templates and/or publish other other projects.

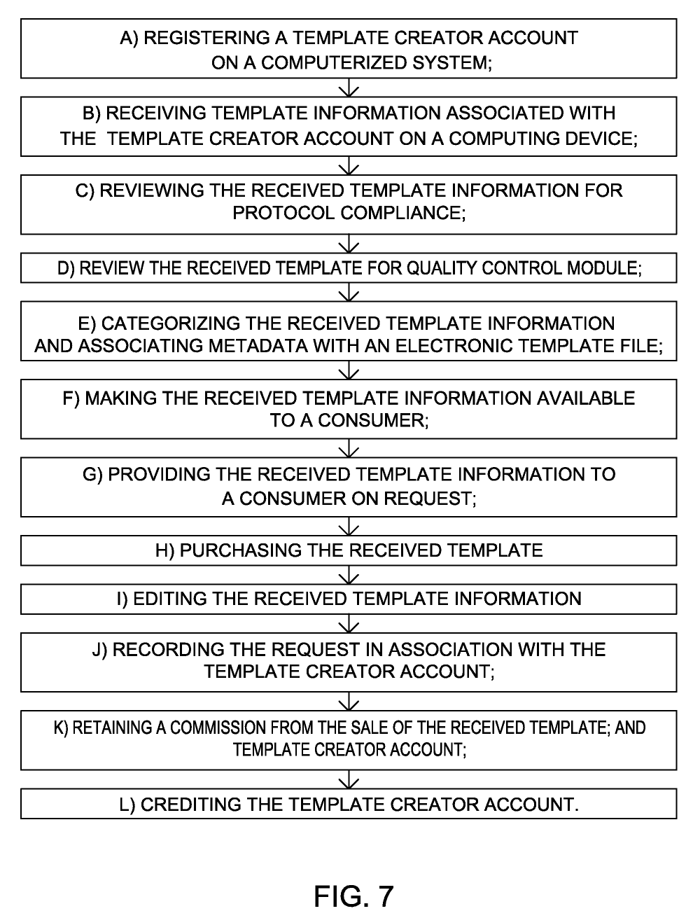

FIG. 7 is a sequence diagram of a method of managing projects using a project management system, according to one embodiment of the invention. The method is configured to manage template receipt, distribution, use, and compensation thereof on a computerized system. The method includes the step of registering a template creator account on a computerized system. The method also includes the step of receiving template information associated with the template creator account on a computing device. In addition, the method includes the step of reviewing the received template information for protocol compliance. The step of reviewing the received template information for protocol compliance includes the step of reviewing the received template for quality control through a quality control module.

In addition, the method includes the step of making the received template information available to a consumer. The step of making the received template information available to a consumer also includes the step of categorizing the received template information and associating metadata with an electronic template file. The method also includes the step of providing the received template information to a consumer on request. The step of providing the received template information to a consumer on request includes the step of purchasing the received template. The step of providing the received template information to a consumer on request also includes the step of editing the received template information. Furthermore, the method includes the step of recording the request in association with the template creator account and crediting the template creator account. The step of recording the request in association with the template creator account includes the step of retaining a commission from the sale of the received template.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the described embodiment is based on a template point currency, real currency may be used in place of template point currency. Similarly, it is envisioned that the described embodiment could perform without sponsorships and down lines. Additionally, although the figures illustrate a particular layout of components and modules, variation may exist so long as the system remains.

Additionally, although the figures illustrate a single user and a single developer, one skilled in the art would appreciate that the project management system is configured to perform its intended function with a plurality of developers and a plurality of users over a network interacting at the same time.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method of managing project templates, the method configured to manage template receipt, distribution, use, and compensation thereof on a computerized system, comprising the steps of:
a) registering a template creator account on a computerized system;
b) receiving template information associated with the template creator account on a computing device;
c) reviewing the received template information for protocol compliance;
d) making the received template information available to a consumer;
e) providing the received template information to a consumer on request;
f) recording the request in association with the template creator account; and
g) crediting the template creator account.

2. The method of claim 1, wherein the step of reviewing the received template information for protocol compliance further comprises the step of reviewing the received template for quality control through a quality control module.

3. The method of claim 1, wherein the step of providing the received template information to a consumer on request further comprises the step of purchasing the received template.

4. The method of claim 1, wherein the step of recording the request in association with the template creator account further comprises the step of retaining a commission from the sale of the received template.

5. The method of claim 1, wherein the step of making the received template information available to a consumer, further comprises the step of categorizing the received template information and associating metadata with an electronic template file.

6. The method of claim 1, wherein the step of providing the received template information to a consumer on request further comprises the step of editing the received template information.

7. A project management system configured to manage template receipt, distribution, use, and compensation thereof on a computerized system, comprising:
a) a management system module configured to manage template information over a computerized system;
b) a quality control module in communication with the management system module configured to review template information from the management system module for protocol compliance;
c) a categorization module in communication with the management system module and configured to categorize template information from the management system module;
d) a registration module in communication with the management system module and configured to register a user for a creator account with the management system module; wherein the creator account is configured to transmit template information to the management system module;
e) a compensation module in communication with the management system module and configured to compensate the creator account for other users purchasing the user's template information;
f) a project editor module is communication with the management system module and configured to edit template information;
g) a display module in communication with the management system module and configured to display template information over a computerized system;
h) a database module in communication with the registration module, the management system module, and the categorization module configured to store template information over a computerized system; and
i) a network module in communication with the management system module configured to couple the system to a computerized network.

8. The system of claim 7 wherein the categorization module further comprises a template module configured to include a name and a description of the template information.

9. The system of claim 7 wherein the categorization module further comprises a keyword module configured to include a keyword of the template information.

10. The system of claim 7 further comprising a commission module in communication with the management system module configured to collect a commission from the template information purchase.

11. The system of claim 7 wherein the database module further includes a library module in communication with the categorization module, the quality control module, and the management system module and configured to store, filter, and group template information.

12. The system of claim 7 wherein the quality control module further includes a system manager module configured to monitor the quality control module for protocol compliance.

13. The system of claim 7 wherein the project editor module further includes a printing module configured to print template information.

14. A project management system configured to manage template receipt, distribution, use, and compensation thereof on a computerized system, comprising:
a) a management system module configured to manage template information over a computerized system;
b) a quality control module in communication with the management system module configured to review template information from the management system module for protocol compliance;
c) a categorization module in communication with the management system module and configured to categorize template information from the management system module;
d) a registration module in communication with the management system module and configured to register a user for a creator account with the management system module; wherein the creator account is configured to transmit template information to the management system module;
e) a compensation module in communication with the management system module and configured to compensate the creator account for other users purchasing the user's template information;
f) a project editor module is communication with the management system module and configured to edit template information;
g) a display module in communication with the management system module and configured to display template information over a computerized system;
h) a database module in communication with the registration module, the management system module, and the categorization module configured to store template information over a computerized system;
i) a commission module in communication with the management system module configured to collect a commission from the template information purchase; and
j) a network module in communication with the management system module configured to couple the system to a computerized network.

15. The system of claim 14 wherein the categorization module further comprises a template module configured to include a name and a description of the template information.

16. The system of claim 15 wherein the categorization module further comprises a keyword module configured to include a keyword of the template information.

17. The system of claim 16 wherein the database module further includes a library module in communication with the categorization module, the quality control module, and the management system module and configured to store, filter, and group template information.

18. The system of claim 17 wherein the quality control module further includes a system manager module configured to monitor the quality control module for protocol compliance.

19. The system of claim 18 wherein the project editor module further includes a printing module configured to print template information.

20. The system of claim 19 wherein the printing module creates a memory book including template information.
